(19) United States
(12) Patent Application Publication
(10) Pub. No.: US 2015/0124327 A1
(43) Pub. Date: May 7, 2015

(54) COATING MATERIAL, OPTICAL COATING FILM, AND OPTICAL ELEMENT

(71) Applicant: Olympus Corporation, Tokyo (JP)

(72) Inventor: TAKAYOSHI TOZUNE, Saitama-shi (JP)

(21) Appl. No.: 14/594,332

(22) Filed: Jan. 12, 2015

Related U.S. Application Data
(63) Continuation of application No. PCT/JP2013/077082, filed on Oct. 4, 2013.

(30) Foreign Application Priority Data
Oct. 31, 2012 (JP) 2012-240906

(51) Int. Cl. C09D 5/00; C08K 7/26; C08K 5/06; G02B 1/11; C08K 5/1535; C08K 5/3415; C08K 5/07; C08K 5/05; C08K 3/22; C08K 5/103

(52) U.S. Cl. CPC C09D 5/006; C08K 3/22; C08K 7/26; C08K 5/06; C08K 5/103; C08K 5/1535; C08K 5/3415; C08K 5/07; C08K 5/05; G02B 1/11; C08K 2003/2241
USPC 359/601; 106/122; 106/287.14; 106/287.19

(57) ABSTRACT

A coating material for forming an optical coating film, which constitutes a reflection preventing film provided on a lens base material, includes a solvent (A), a compound (B) which contains a polymerizable functional group, and a metal oxide particle (C), in which the solvent (A) contains at least one solvent (A1) selected from the group consisting of propylene glycol monopropyl ether, propylene glycol monomethyl ether, and propylene glycol monomethyl ether acetate, and the compound (B) contains a compound (B1) which contains two or more urethane bonds in one molecule, or metal alkoxide (B2).

This application is a continuation application based on PCT/JP2013/077082, filed on Oct. 4, 2013, claiming priority based on Japanese Patent Application No. 2012-240906, filed in Japan on Oct. 31, 2012. The contents of both the Japanese Patent Application and the PCT application are incorporated herein by reference.

### BACKGROUND OF THE INVENTION

1. Field of the Invention

The present invention relates to a coating material, an optical coating film, and an optical element.

2. Description of the Related Art

In order to improve imaging performance by suppressing reflection and increasing light transmittance, a reflection preventing film is formed on an optical surface of a lens. The reflection preventing film often has a multilayer structure in which a plurality of layers having different refractive indexes are stacked. It is possible to realize a low reflectivity over a wide range of wavelengths by employing such a multilayer structure.

As a method for forming an optical thin film on a surface of a base material, a vacuum deposition method has been used in the related art.

In the vacuum deposition method, a solid material having a predetermined refractive index is evaporated by heating at a high temperature under vacuum and is deposited on a surface of a base material to form a thin film. In order for the thin film to have a multilayer structure and to be used as a reflection preventing film, each of the solid materials having different refractive indexes is sequentially heated under vacuum so as to form thin films.

However, since high temperature heating is performed under vacuum in a dry process that is represented as a vacuum deposition method, the time for forming an optical thin film is increased. Particularly, when a reflection preventing film having a multilayer structure is formed by a dry process, a film forming process is repeated multiple times and thus the time for film formation is particularly increased.

In order to solve the above-described problem, a wet coating method in which an optical thin film is formed under atmospheric pressure has been proposed recently. In the wet coating method, a coating material containing a film forming component and a solvent for dissolving the film forming component is applied to a base material and subjected to treatment such as drying to form a coating film (optical thin film).

As the coating material used for forming the reflection preventing film, a curable coating material which is cured by ultraviolet irradiation or heating is mainly used. The curable coating material is applied to a base material and then cured by ultraviolet irradiation or heating to form a cured coating film.

In order to adjust a refractive index, a curable coating material containing inorganic fine particles is proposed (for example, refer to Japanese Unexamined Patent Application First Publication No. 2008-185956 and Japanese Unexamined Patent Application First Publication No. 2010-083967). In this case, a coating film in which inorganic fine particles are dispersed in a matrix of resin is formed. By adjusting the refractive index of the inorganic fine particle, the refractive index of the coating film to be formed can be adjusted.

### SUMMARY OF THE INVENTION

According to a first aspect of the present invention, there is provided a coating material for forming an optical coating film which constitutes a reflection preventing film provided on a lens base material, including a solvent (A), a compound (B) which contains a polymerizable functional group, and a metal oxide particle (C), in which the solvent (A) contains at least one solvent (A1) selected from a group consisting of propylene glycol monopropyl ether, propylene glycol monomethyl ether, and propylene glycol monomethyl ether acetate, and the compound (B) contains a compound (B1) which contains two or more urethane bonds in one molecule or metal alkoxide (B2).

In the coating material according to a second aspect of the present invention, the solvent (A) in the first aspect may further contain at least one solvent (A2) selected from a group consisting of γ-butyrolactone, 4-hydroxy-4-methyl-2-pentanone, N-methyl-2-pyrrolidone, and 3-methoxy-1-butanol, and a content of the solvent (A2) may be 0.5% by mass to 5% by mass with respect to a total amount of the coating material.

According to a third aspect of the present invention, there is provided an optical coating film, which constitutes a reflection preventing film provided on a lens base material, including the coating material according to the first aspect or the second aspect.

According to a fourth aspect of the present invention, there is provided an optical element including a lens base material, and a reflection preventing film provided on the lens base material, in which the reflection preventing film is a multilayer film in which three or more layers are stacked, and at least one layer among the layers which constitutes the multilayer film is an optical coating film formed of the coating material according to the first aspect or the second aspect.

### BRIEF DESCRIPTION OF THE DRAWINGS

FIG. 1 is a cross-sectional view schematically showing an embodiment example of an optical element of the present invention.

FIG. 2 is a graph showing the result of unevenness evaluation (2) of an optical coating film prepared in Comparative Example 1.

FIG. 3 is a graph showing the result of unevenness evaluation (2) of an optical coating film prepared in Example 1.

FIG. 4 is a graph showing the result of unevenness evaluation (2) of an optical coating film prepared in Example 2.

FIG. 5 is a graph showing the result of unevenness evaluation (2) of an optical coating film prepared in Comparative Example 2.

FIG. 6 is a graph showing the result of unevenness evaluation (2) of an optical coating film prepared in Comparative Example 3.

FIG. 7 is a graph showing the result of unevenness evaluation (2) of an optical coating film prepared in Example 3.

FIG. 8 is a graph showing the result of unevenness evaluation (2) of an optical coating film prepared in Example 4.

FIG. 9 is a graph showing the result of unevenness evaluation (2) of an optical coating film prepared in Example 5.

FIG. 10 is a graph showing the result of unevenness evaluation (2) of an optical coating film prepared in Example 6.

FIG. 11 is a graph showing the result of unevenness evaluation (2) of an optical coating film prepared in Example 7.

FIG. 12 is a graph showing the result of unevenness evaluation (2) of an optical coating film prepared in Example 8.

FIG. 13 is a graph showing the result of unevenness evaluation (2) of an optical coating film prepared in Comparative Example 4.

FIG. 14 is a graph showing the result of reflectivity measurement of an optical element prepared in Example 9.

### DETAILED DESCRIPTION OF THE INVENTION

[Coating Material]

A coating material of the present invention is a coating material for forming an optical coating film which constitutes a reflection preventing film provided on a lens base material and contains a solvent (A), a compound (B) having a polymerizable functional group (hereinafter, referred to as a “component (B)”), and a metal oxide fine particle (C) (hereinafter, referred as to a “component (C)”).

When the polymerizable functional group included in the component (B) is a radical polymerizable functional group, the coating material of the present invention preferably further contains a photopolymerization initiator (D) (hereinafter, referred to as a “component (D)”).

<Solvent (A)>

The solvent (A) is a solvent for uniformly dissolving the component (B) which is a coating film forming component.

The solvent (A) contains at least one solvent (A1) selected from the group consisting of propylene glycol monopropyl ether, propylene glycol monomethyl ether, and propylene glycol monomethyl ether acetate.

When an optical coating film is formed by applying the coating material to the lens base material, drying and curing the coating material, the occurrence of thickness unevenness can be suppressed by containing the solvent (A1), and thus, an optical coating film having excellent thickness uniformity can be formed.

The solvent (A1) may be used alone or may be used in combination of two or more.

The content of the solvent (A1) in the coating material is preferably 70% by mass to 99% by mass, and more preferably 85% by mass to 97% by mass with respect to a total amount of the coating material (100% by mass). When the content of the solvent is 70% by mass or more, the occurrence of thickness unevenness can be sufficiently suppressed, and when the content of the solvent is 99% by mass or less, a coating film having a suitable thickness as an optical thin film can be formed.

The solvent (A) contained in the coating material may contain only the solvent (A1), but preferably further contains at least one solvent (A2) selected from the group consisting of γ-butyrolactone, 4-hydroxy-4-methyl-2-pentanone, N-methyl-2-pyrrolidone, and 3-methoxy-1-butanol.

Since the solvent (A2) is further contained, the effect of suppressing the occurrence of thickness unevenness is further enhanced. In addition, the generation of foreign substances during the formation of the optical coating film can be suppressed.

The solvent (A2) may be used alone or may be used in combination of two or more at an arbitrary ratio.

However, the content of the solvent (A2) in the coating material is set to be 5% by mass or less with respect to the total amount of the coating material. When the content of the solvent (A2) is more than 5% by mass, there are possibilities of the coating material not being easily dried after the application of the coating material and the film formability being deteriorated.

Considering these possibilities, the content of the solvent (A2) in the coating material is preferably 0.5% by mass to 5% by mass and more preferably 1% by mass to 3% by mass with respect to the total amount of the coating material.

The solvent (A) may contain a solvent (hereinafter, referred to as a “solvent (A3)”) other than the solvents (A1) and (A2) within a range not impairing the effect of the present invention, as required.

Examples of the solvent (A3) include methanol, ethanol, isopropyl alcohol, n-propyl alcohol, n-butyl alcohol, isobutyl alcohol, sec-butyl alcohol, tert-butyl alcohol, acetone, methyl ethyl ketone, diethyl ketone, methyl isobutyl ketone, ethyl isobutyl ketone, diisobutyl ketone, cyclohexanone, 1,4-dioxane, ethylene glycol monomethyl ether, ethylene glycol monoethyl ether, ethylene glycol monomethyl ether acetate, methyl acetate, ethyl acetate, butyl acetate, ethyl lactate, diethylene glycol dimethyl ether, propylene glycol monoethyl ether, propylene glycol monopropyl ether, diethylene glycol monoethyl ether acetate, diethylene glycol monobutyl ether acetate, 2-methoxyethanol, and hydrofluoroethers. These solvents may be used alone or may be used in combination of two or more at an arbitrary ratio.

A total content of the solvent (A1) and the solvent (A2) in the solvent (A) is preferably 35% by mass or more, more preferably 70% by mass or more, and particularly preferably 100% by mass with respect to the total amount of the solvent (A) in terms of the effect of the present invention. That is, the solvent (A) is preferably composed of the solvent (A1) or composed of the solvent (A1) and the solvent (A2).

<Component (B)>

The component (B) is a compound having a polymerizable functional group. The component (B) is a film forming component which is polymerized (cured) by irradiation with active energy rays such as ultraviolet rays or by heat.

The polymerizable functional group is a functional group capable of undergoing a polymerization (such as radical polymerization, cationic polymerization, or polycondensation) reaction by active energy rays such as ultraviolet rays, infrared rays, or electron beams, or heating. Examples of the polymerizable functional group include a radical polymerizable functional group such as an (meth)acryloyl group, a cationic polymerizable functional group such as a glycidyl group, and a hydroxyl group produced by hydrolysis of an alkoxy group bonded to a metal atom.

In the specification, the (meth)acryloyl group means both an acryloyl group and a methacryloyl group.

The component (B) may be a monofunctional compound having one polymerizable functional group in one molecule or may be a polyfunctional compound having a plurality of polymerizable functional groups in one molecule and is preferably a polyfunctional compound.

The coating material of the present invention contains a compound (B1) having two or more urethane bonds in one molecule (hereinafter, referred to as a “component (B1)”) or a metal alkoxide (B2) (hereinafter, referred to as a “component (B2)”). Accordingly, it is possible to effectively suppress the occurrence of unevenness. In addition, when the coating material is dropped on a surface to be applied and is spread by spin coating, a non-wetting portion in which the coating material is not applied is not easily generated.

The component (B1) is a compound having two or more urethane bonds (—NH—C(═O)—O—) in one molecule.

The polymerizable functional group included in the component (B1) is preferably a radical polymerizable functional group such as an (meth)acryloyl group or a glycidyl group and particularly preferably an (meth)acryloyl group.

The number of the polymerizable functional group included in the component (B1) is preferably 6 or more and more preferably 8 to 10.

Specific examples of the component (B1) include
bis(2,2-bis(acryloxymethyl)-3-acryloxypropyl-N,N′-hexane-1,6-diylcarbamate, 1,3,5-tris-(6-(2,2-bis(acryloxymethyl)-3-acryloxypropyloxy)carbonylaminohexyl)-1,3,5-triazine-2,4-6-trione, and
bis(2,2-bis(acryloxymethyl)-3-(2,2-bis(acryloxymethyl)-3-acryloxypropyl)propyl)-N,N′-hexane-1,6-diyldicarbamate. Any of these compounds may be used alone or may be used in combination of two or more at an arbitrary ratio.

The component (B2) is metal alkoxide. The metal alkoxide is a compound having a metal atom and an alkoxy group bonded to the metal atom. In the metal alkoxide, the alkoxy group is changed to a hydroxyl group by hydrolysis. An —O-M-O-bond (M is a metal atom) is formed by a polycondensation reaction between molecules having a hydroxyl group bonded to the metal atom.

Examples of the metal alkoxide include a compound expressed by the following formula (I).

(R′)ₘ₋ₙM(OR)ₙ (I)

In the formula, M represents a metal atom, m represents the valence of M, and n represents an integer of 2 or more.

Examples of the metal atom in M include a silicon atom.

R represents an alkyl group and preferably an alkyl group having 1 to 5 carbon atoms.

R′ represents a nonhydrolyzable organic group and examples thereof include a hydrocarbon group (for example, an alkyl group, an alkenyl group, or an aryl group) which may have a substituent (for example, a methyl group or an ethyl group).

As the metal alkoxide, particularly, a compound, in which M in the formula (I) is preferably Si and m is 4, (alkoxysilane) is preferably used.

Specific examples of alkoxysilane include tetraalkoxysilanes such as tetramethoxysilane, tetraethoxysilane, and tetraisopropoxysilane; trialkoxysilanes such as methyl trimethoxysilane, methyl triethoxysilane, methyl triisopropoxysilane, phenyltrimethoxysilane, and phenyltriethoxysilane; and dialkoxysilanes such as dimethyldimethoxysilane, and dimethyldiethoxyilane. Any of these compounds may be used alone or may be used in combination of two or more at an arbitrary ratio.

The coating material of the present invention may further contain a compound (hereinafter, referred to as a “component (B3)”) other than the component (B1) and the component (B2) as the component (B).

The component (B3) may be a component polymerizable with the component (B1) or the component (B2).

Specific examples of the component (B3) polymerizable with the component (B1) include polyol poly(meth)acrylates such as trimethylolpropane tri(meth)acrylate, trimethylolpropane ethoxy tri(meth)acrylate, pentaerythritol tri(meth)acrylate, pentaerythritol ethoxy tetra(meth)acrylate, pentaerythritol tetra(meth)acrylate, dipentaerythritol hexa(meth)acrylate, and dimethylolpropane tetra(meth)acrylate. Any of these compounds may be used alone or may be used in combination of two or more at an arbitrary ratio.

The content of the component (B) in the coating material is preferably 1% by mass to 20% by mass, and more preferably 3% by mass to 10% by mass with respect to the total amount of the coating material (100% by mass). When the content of the component (B) is 1% by mass or more, a coating film having a desired thickness can be easily formed and the optical properties can be sufficiently exhibited. When the content thereof is 20% by mass or less, the component (B) is sufficiently uniformly dissolved in the solvent (A) and thus the film formability can be improved. In addition, a coating film having reduced thickness unevenness and few foreign substances can be formed.

The ratio of the component (B1) or the component (B2) in the component (B) is preferably 50% by mass or more and particularly preferably 100% by mass with respect to the total amount of the component (B) in terms of the effect of the present invention. That is, the component (B) is particularly preferably composed of the component (B1) or composed of the component (B2).

<Component (C)>

The component (C) is a metal oxide particle.

The component (C) is used for adjusting the refractive index of an optical coating film to be formed.

Examples of the metal oxide in the component (C) include TiO₂, ZrO₂, Nb₂O₃, Ta₂O₅, CeO₂, HfO₂, and SiO₂. The metal oxide can be appropriately selected according to a desired refractive index of the component (C).

The average particle size of the component (C) is preferably 100 nm or less and more preferably 2 nm to 70 nm. When the average particle size is more than 100 nm, scattered light is generated on the formed coating film and opacity occurs. Then, the film may not be suitable for optical use.

The particle shape of the component (C) is not particularly limited and any shape such as a spherical shape, a needle-like shape, or a lump shape can be arbitrarily selected.

The component (C) may be a solid particle having a dense crystal structure or may be a particle having a hole therein (such as a hollow shape or a porous shape). The particle can be appropriately selected according to a desired refractive index of the component (C). Even when a material constituting the particle (metal oxide) is the same, the higher the inside porosity is, the more the air is included. Thus, the refractive index of the particle is decreased.

The component (C) may be used alone or may be used in combination of two or more at an arbitrary ratio.

As the component (C), a component corresponding to a desired refractive index of an optical coating film to be formed is selected.

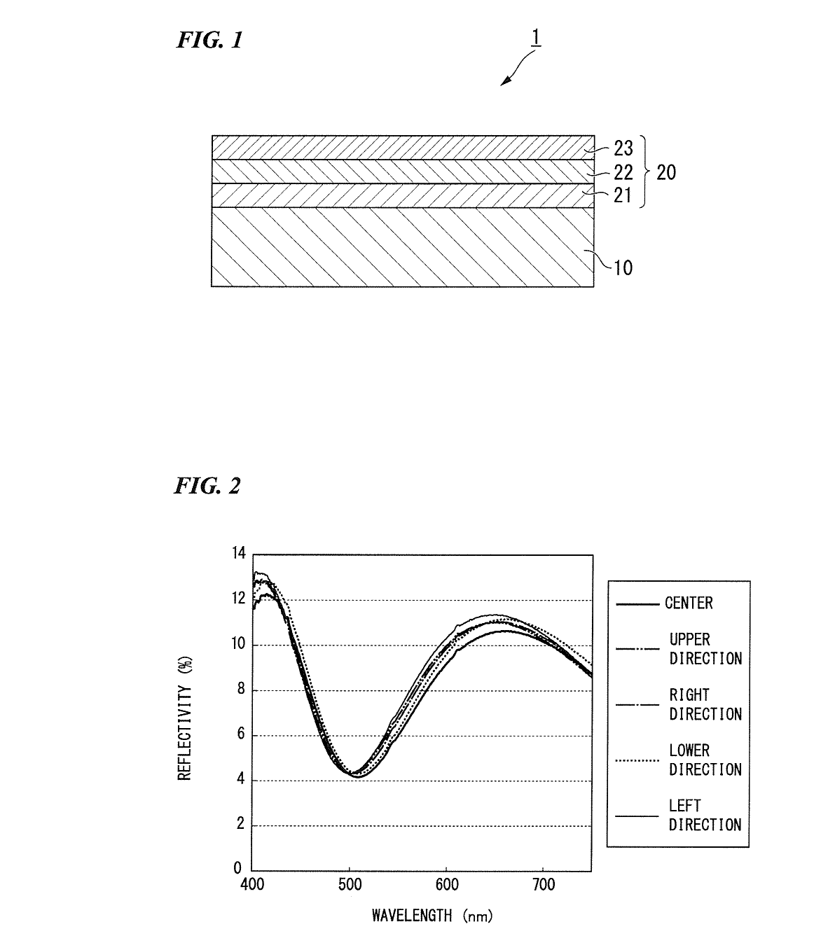

For example, when a high refractive index layer 22 in a reflection preventing film 20 of the embodiment shown in FIG. 1 which will be described later is formed as an optical coating film, a particle having a refractive index of 1.8 to 2.4 (hereinafter, referred to as a “component (C1)”) is preferably used as the component (C). As the component (C1), typically, a solid particle is used and examples thereof include TiO₂ solid particles, Bi₂O₃ solid particles, SnO₂ solid particles, Y₂O₃ solid particles, ZrO₂ solid particles, ZnO solid particles, tin doped indium oxide (ITO) solid particles, and antimony doped tin oxide (ATO) solid particles.

When a low refractive index layer 23 in the reflection preventing film 20 of the embodiment shown in FIG. 1 which will be described later is formed as an optical coating film, a particle having a refractive index of 1 to 1.5 (hereinafter, referred to as a “component (C2)”) is preferably used and a particle having a refractive index of 1.1 to 1.2 is more preferably used as the component (C). As the component (C2), typically, a particle having a hole therein is used and examples thereof include SiO₂ hollow particles.

The content of the component (C) in the coating material is preferably 0.01% by mass to 5% by mass and more preferably 0.1% by mass to 3% by mass with respect to the total amount of the coating material (100% by mass). When the content of the component is 0.1% by mass or more, a coating film having a low refractive index can be formed. When the content thereof is 3% by mass or less, an even coating film can be formed.

<Component (D)>

The component (D) is a photopolymerization initiator. When the polymerizable functional group included in the component (B) is a radical polymerizable functional group such as an (meth)acryloyl group, curing by active energy rays is easily performed by using the component (D) together.

The component (D) is not particularly limited as long as the component generates a radical. Examples thereof include a photocleavage type photopolymerization initiator, and a hydrogen abstraction type photopolymerization initiator.

Examples of the photocleavage type photopolymerization initiator include benzoins such as benzoin, benzoin methyl ether, benzoin isopropyl ether, and α-acrylbenzoin, benzil, 2-methyl-2-morpholino(4-thiomethylphenyl)propan-1-one, 2-benzyl-2-dimethylamino-1-(4-morpholinophenyl)-1-butanone, benzyl methyl ketal, 1-hydroxycyclohexyl phenyl ketone, 2-hydroxy-2-methyl-1-phenylpropan-1-one, 1-(4-isopropyl phenyl)-2-hydroxy-2-methyl propan-1-one, 4-(2-hydroxyethoxyl)phenyl-(2-hydroxy-2-propyl) ketone, 4-(2-acryloyl-oxyethoxy)phenyl-2-hydroxy-2-propyl ketone, and diethoxyacetophenone.

Examples of commercially available products include “Irgarcure 907”, “Irgarcure 369”, “Irgarcure 651”, “Irgarcure 184”, “ZLI 3331”, “Lucirin TPO”, and “CGI 1700” (all manufactured by BASF); “Darocur 1173” and “Darocur 1116” (both manufactured by Merck KGaA); “Esacure KIP 100” (manufactured by Lamberti Spa); and “BTTB” (manufactured by NOF CORPORATION).

Examples of the hydrogen abstraction type photopolymerization initiator include aryl ketone-based initiators such as benzophenone, p-methylbenzophenone, p-chlorobenzophenone, tetrachlorobenzophenone, benzoyl methyl benzoate, 4-phenyl benzophenone, hydroxylbenzophenone, 4-benzoyl-4′-methyl-diphenylsulfide, 2-isopropylthioxanthone, 2,4-dimethylthioxanthone, 2,4-diethyithioxanthone, 2,4-dichlorothioxanthone, and acetophenone; dialkylamino aryl ketone-based initiators such as 4,4′-bis(diethylamino)benzophenone, 4,4′-bis(dimethylamino)benzophenone, p-methylaminoisoamyl benzoate, and p-dimethylaminoacetophenone; and polycyclic carbonyl-based initiators of thioxanthone type, xanthone type, and halogen substituted type thereof.

The component (D) may be used alone or may be used in combination of two or more.

The content of the component (D) in the coating material is preferably 2 parts by mass to 10 parts by mass and more preferably 3 parts by mass to 7 parts by mass with respect to the total amount of the component (B) (100% by mass). When the content of the component (D) is 2 parts by mass or more, the curability can be sufficiently ensured. On the other hand, when the content of the component (D) is 10 parts by mass or less, a coating film having excellent abrasion resistance is easily obtained. In addition, since the obtained coating film can be prevented from turning yellow, the transparency can be improved.

<Other Components>

When the coating material of the present invention contains the component (B2) as the component (B), water is required for the hydrolysis of the metal alkoxide and thus the coating material preferably further contains water.

The content of water is preferably 0.5 times to 2 times of the molar ratio of the metal alkoxide.

When the coating material of the present invention contains the component (B2) as the component (B), the coating material may further contain a catalyst (E) (hereinafter, referred to as a “component (E)”) to accelerate the hydrolysis and polycondnesation reaction of the metal alkoxide.

Examples of the catalyst (E) include acids such as hydrochloric acid, acetic acid, sulfuric acid, and nitric acid, NaOH, KOH, and NH₄OH.

The content of the component (E) is preferably 0.001% by mass to 0.5% by mass and more preferably 0.01% by mass to 0.1% by mass with respect to the total amount of the coating material (100% by mass).

The coating material of the present invention may contain components other than the above-described component (B), component (C), component (D), and component (E) within a range not impairing the effect of the present invention.

Examples of the other components include additives, used as a typical optical coating material, such as an antioxidant, an ultraviolet absorber, an anti-fogging agent, a flame retardant, a plasticizer, a polymerization inhibitor, a surfactant, an antifungal agent, a slip agent, an antifoaming agent, an antistatic agent, a thickener, and a dispersing agent.

Preferred embodiments of the coating material of the present invention include the following first embodiment and second embodiment.

### First Embodiment

A coating material according to a first embodiment of the present invention contains the component (B1) as the component (B) and the component (C1) as the component (C).

In the coating material according to the first embodiment of the present invention, the component (B1) preferably has a radical polymerizable functional group such as a (meth)acryloyl group as a polymerizable functional group and further contains the component (D).

The component (C1) is preferably at least one selected from the group consisting of TiO₂ solid particles, Bi₂O₃ solid particles, SnO₂ solid particles, Y₂O₃ solid particles, ZrO₂ solid particles, ZnO solid particles, ITO solid particles, and ATO solid particles.

When the coating material according to the first embodiment of the present invention is formed into an optical coating film, the refractive index thereof is preferably 1.70 to 2.00, and more preferably 1.80 to 1.90. When a multilayer film in which three or more layers are stacked is formed as a reflection preventing film, the above-described optical coating film is useful as a high refractive index layer having the highest refractive index among the layers in the multilayer film (for example, the high refractive index layer 22 in the reflection preventing film 20 of the embodiment shown in FIG. 1 described later) as long as the refractive index is within the above-described range.

The refractive index of the optical coating film can be adjusted according to the type and the content of the component (C). For example, the higher the content of the component (C1) is, the higher the refractive index of the optical coating film is.

### Second Embodiment

A coating material of a second embodiment contains the component (B2) as the component (B) and the component (C2) as the component (C).

The coating material of the second embodiment preferably further contains water and more preferably further contains the component (E).

Examples of the component (C2) preferably include SiO₂ hollow particles.

When the coating material of the second embodiment is formed into an optical coating film, the refractive index thereof is preferably 1.2 to 1.40, and more preferably 1.25 to 1.35. When a multilayer film in which three or more layers are stacked is formed as the reflection preventing film, the above-described optical coating film is useful as a low refractive index layer having the lowest refractive index among the layers in the multilayer film (for example, the low refractive index layer 23 in the reflection preventing film 20 of the embodiment shown in FIG. 1 described later) as long as the refractive index is within the above-described range.

The refractive index of the optical coating film can be adjusted according to the type and the content of the component (C). For example, the higher the content of the component (C2) is, the lower the refractive index of the optical coating film is.

Here, the term of “refractive index” used in the specification refers to a refractive index with respect to light having a wavelength of 550 m.

The refractive index of the component (C) can be calculated by preparing multiple kinds of solutions having different concentrations of the dispersed component (C), and extrapolating a relationship between the concentrations of these solutions and the refractive index. The refractive index of the solution can be measured by KPR-200 (manufactured by Shimazu Device Corporation).

The refractive index of the optical coating film can be measured as follows.

That is, a reflectivity r of a coating film formed by applying the coating material to a glass base material, and drying and curing the coating material is measured to obtain the refractive index of the coating film by the following formula (II).

r=(n₀−n₁)²/(n₀+n₁)² (II)

In the formula (II), “n₀” represents the refractive index of the air and “n₁” represents the refractive index of the coating film.

<Effects>

Since the coating material according to each of the above-described embodiment contains the solvent (A1), thickness unevenness does not easily occur while the coating material is cured after being applied to the surface of the lens base material to be applied, and thus, an optical coating film having excellent thickness uniformity can be formed. Since the thickness uniformity is excellent, the optical coating film also has reduced unevenness in optical properties.

It can be considered that the reason for exhibiting the above-described effects is that the volatilization rate of the solvent (A1) is not excessively high and the solubility of the component (B) in the solvent (A2) and the dispersibility of the component (C) in the solvent (A2) are good.

In the related art, as the solvent (A) of the coating material for forming an optical coating film, a solvent that relatively easily volatilizes has been used in terms of a short drying time and good productivity. When such a coating material is applied by, for example, spin coating, the solvent (A) volatilizes while the coating material is being applied to an optical coating film forming surface, and thus, the viscosity of the coating material is increased in some cases. Due to this, it can be considered that the surface of the coating film (liquid surface) is wavy or is not wet (non-wetting state) by the coating material and the coating film is dried in the above-described state so as to cause unevenness.

In the present invention, since the solvent (A) includes the solvent (A1), the viscosity of the coating material is decreased. Accordingly, it can be considered that the wavy state and the non-wetting conditions of the surface of the coating film are suppressed, and thus, the occurrence of unevenness is improved. In addition, since the solubility of the component (B) and the dispersibility of the component (C) are good, the component (B) is stably dissolved in the coating material and the component (C) is stably dispersed. Thus, it can be considered that thickness unevenness resulting from generation of precipitations of the component (B) and aggregates of the component (C) is suppressed.

When the component (B1) or the component (B2) is used as the component (B), the occurrence of unevenness can be further suppressed. For example, when the optical coating film forming surface is made of a highly hydrophilic material such as glass, since the polarity of the component (B1) or the component (B2) is high, the wettability of the coating material containing these components to the optical coating film forming surface is increased. Thus, a non-wetting portion is not easily generated and the occurrence of unevenness is further suppressed.

When the coating material of the present invention further contains the solvent (A2), the effect of suppressing the generation of foreign substances is obtained as well as the effect of suppressing the occurrence of unevenness.

It can be considered that the reason for exhibiting the above-described effects is that the volatilization rate of the solvent (A2) is much lower than the volatilization rate of the solvent (A1) and the solubility of the component (B) and the dispersibility of the component (C) in the solvent (A2) are better than in the solvent (A1).

When the volatilization rate of the solvent (A2) is lower than the volatilization rate of the solvent (A1), the effect obtained by the use of the solvent (A1) is further improved as described above. Although the volatilization rate of the solvent (A2) is low, the film formability can be sufficiently ensured by setting the content thereof in the coating material to be 5% by mass or less.

In addition, since the solubility of the component (B) and the dispersibility of the component (C) in the solvent (A2) are better, precipitation of the component (B) and aggregation of the component (C) in the coating material are effectively suppressed. Therefore, it is possible to prevent precipitation of the component (B) and aggregation of the component (C) in the coating material or adhesion of the components to the surface of the coating film.

[Optical Coating Film]

An optical coating film of the present invention is an optical coating film which constitutes the reflection preventing film provided on the lens base material and is formed of the coating material of the present invention.

The thickness of the optical coating film is preferably 10 nm to 200 nm and more preferably 20 nm to 150 nm. When the thickness thereof is 10 nm or more, the reflection preventing film containing the coating material exhibits sufficient optical properties. On the other hand, when the thickness is 200 nm or less, the shrinkage during curing can be suppressed.

For example, the optical coating film of the present invention can be formed by applying the coating material of the present invention to the base material (lens base material or the like), drying the coating material to form a coating film, and curing the coating film. Drying and curing may be performed at the same time.

Examples of the application method include a spin coating method, a dipping method, a spraying method, a roll coating method, and an ink jet method. Among these methods, in terms of thickness control, a spin coating method is suitable. In the spin coating method, for example, the coating material is dropped on the base material and the base material is rotated at a high speed. The dropped coating material spreads along the surface of the base material in a short period of time by centrifugal force. At the same time, the volatilization of the solvent (A) also proceeds and a coating film is formed.

The temperature of the coating material at the application is preferably 15° C. to 35° C.

The drying is preferably performed under a temperature condition of 20° C. to 150° C.

The coating film can be cured by irradiation with active energy rays or heat treatment.

When the coating material is cured by irradiation with active energy rays, ultraviolet rays, infrared rays, or electron beams can be used as the active energy rays. Among these rays, in terms of a curing time, ultraviolet rays are preferable. When the coating material is irradiated with ultraviolet rays, the type of the light source is not particularly limited and light sources such as an LED light source, a high pressure mercury lamp, and a metal halide lamp can be used. These may be used in combination.

When the coating material is cured by heat treatment, the temperature of the heat treatment can be appropriately selected according to the type of the component (B). For example, when the component (B2) is used, the temperature is preferably 10° C. to 300° C. and more preferably 20° C. to 150° C.

Since the optical coating film of the present invention is formed of the coating material of the present invention, the thickness uniformity is excellent as described above. Since the thickness uniformity is excellent, the optical coating film also has reduced unevenness in optical properties. Particularly, when the coating material further containing the solvent (A2) is used as the coating material of the present invention, an optical coating film having few foreign substances can be obtained.

[Optical Element]

An optical element of the present invention is an optical element including a lens base material, and a reflection preventing film provided on the lens base material. The reflection preventing film is a multilayer film in which three or more layers are stacked and at least one layer among layers constituting the multilayer film is an optical coating film formed of the above-described coating material of the present invention (that is, the optical coating film of the present invention).

FIG. 1 is a cross-sectional view schematically showing an embodiment example of the optical element of the present invention.

An optical element 1 of the embodiment includes a lens base material 10 and a multilayer film 20 formed on the base material 10.

As the material for the lens base material 10, glass, plastic, and the like can be used. Examples of the plastic include various kinds of polycarbonates and cycloolefin polymers. Among these, when glass having a higher refractive index (high reflectivity) is used, a remarkable reflection preventing effect can be obtained at the time when the reflection preventing film is formed. Therefore, glass having a higher refractive index (high reflectivity) is particularly preferable.

Examples of the shape of the lens base material 10 include a flat surface, a concave surface, and a convex surface and the shape thereof is not particularly limited.

The multilayer film 20 includes an intermediate refractive index layer 21 formed on the lens base material 10, a high refractive index layer 22 formed on the intermediate refractive index layer 21, and a low refractive index layer 23 formed on the high refractive index layer 22.

The refractive index of the intermediate refractive index layer 21 is preferably 1.55 to 1.60. When the refractive index of the intermediate refractive index layer is within the above-described range, the refractive index differences between other layers (high refractive index layer 22, low refractive index layer 23, and the like) and the intermediate reflective index layer can be easily obtained.

The refractive index of the high refractive index layer 22 is preferably 1.70 to 2.00. When the refractive index of the high refractive index layer is within the above-described range, the refractive index differences between other layers and the intermediate refractive index layer 21 are easily obtained and thus an optical element 1 having excellent reflection preventing performance is easily produced.

The refractive index of the low refractive index layer 23 is preferably 1.25 to 1.40. When the refractive index of the low refractive index layer is within the above-described range, it is effective to maintain a low reflectivity over a wide range of wavelengths and also effective to maintain a low reflectivity with respect to not only directly incident light but also light incident from a wide range of angles, and thus, the low refractive index layer is useful as an optical thin film.

Since the multilayer film 20 is composed of three layers having different refractive indexes, a low reflectivity can be maintained over a wide range of wavelengths and the range capable of dealing with wavelengths is wide. Accordingly, the multilayer film 20 is suitable as a reflection preventing film.

In the embodiment, of those mentioned above, the high refractive index layer 22 is an optical coating material formed of the coating material of the first embodiment of the present invention and the low refractive index layer 23 is an optical coating film formed of the coating material of the second embodiment of the present invention. However, the present invention is not limited thereto and may be an optical coating film in which at least one layer is formed of the coating material of the present invention.

The material constituting the intermediate refractive index layer 21 is not particularly limited. However, an optical coating material formed of the coating material containing the solvent (A) and the component (B) (hereinafter, referred to as a “coating material for an intermediate refractive index layer”) is preferable.

Examples of the solvent (A) include the same solvents as described above, and the solvent preferably contains the solvent (A1). Thus, the intermediate refractive index layer 21 having reduced thickness unevenness can be formed on the surface of the lens base material 10.

The solvent (A) preferably contains the solvent (A2) in addition to the solvent (A1).

Thus, the intermediate refractive index layer 21 having reduced thickness unevenness and few foreign substances can be formed on the surface of the lens base material 10.

Since the thickness unevenness and foreign substances are reduced, defects at the time of the formation of the high refractive index layer 22 and the low refractive index layer 23 to be formed thereon (unevenness, foreign substances, non-wetting, or the like) can be also suppressed.

However, the content of the solvent (A2) is preferably 5% by mass or less and more preferably 0.5% by mass to 5% by mass with respect to the total amount of the coating material as in the coating material of the present invention.

Examples of the component (B) include the same components as described above and the component (B1) or the component (B2) is preferable.

The coating material for an intermediate refractive index layer may or may not contain the component (C) and preferably does not contain the component (C).

The coating material for an intermediate refractive index layer may further contain the component (D) or the component (E) as required.

The coating material for an intermediate refractive index layer may further contain components other than the component (B), the component (C), the component (D), and the component (E). Examples of the other components include the same components as described above.

As the coating material for an intermediate refractive index layer, a coating material excluding the component (C) from the coating material of the first embodiment of the present invention or a coating material excluding the component (C) from the coating material of the second embodiment of the present invention is preferable.

The optical element 1 can be produced by the following manner, for example.

First, the coating material for an intermediate refractive index layer is applied to the lens base material 10, dried, and cured to form an optical coating film (intermediate refractive index layer 21).

Next, the coating material according to the first embodiment of the present invention is applied to the intermediate refractive index layer 21, dried, and cured to form an optical coating film (high refractive index layer 22).

Next, the coating material according to the second embodiment of the present invention is applied to the high refractive index layer 22, dried, and cured to form an optical coating film (low refractive index layer 23). Thus, the optical element 1 having the multilayer film 20 on the surface of the lens base material 10 is obtained.

The formation of each optical coating film can be implemented in the same manner as in the description of each optical coating film.

The optical element of the present invention is not limited to the optical element 1 shown in FIG. 1. The multilayer film 20 included in the optical element 1 shown in FIG. 1 is a multilayer film having a three-layer structure. However, the multilayer film included in the optical element of the present invention may be a multilayer film in which four or more layers are stacked. For example, the multilayer film may be a multilayer film having a four-layer structure having a second intermediate refractive index layer between the high refractive index layer 22 and the low refractive index layer 23 in the multilayer film 20.

The multilayer film included in the optical element of the present invention is not particularly limited as long as the film has a structure in which three or more layers are stacked. However, as the number of stacked layers increases, it takes much labor for film formation. Accordingly, considering the reflection preventing performance and the productivity of the optical element, the multilayer film is preferably a multilayer film in which three to five layers are stacked.

The optical element of the present invention is suitable as an optical element of optical instruments such as a camera, a microscope, an endoscope, and a semiconductor exposure apparatus.

### EXAMPLES

Hereinafter, the present invention will be described in more detail using Examples and Comparative Examples. However, the present invention is not limited to the following examples.

Materials, measurement methods, and evaluation methods used in Examples and Comparative Examples will be shown below.

[Used Material] <Solvent (A1)>
PNP: propylene glycol monopropyl ether (manufactured by Wako Pure Chemical Industries, Ltd.)
PGME: propylene glycol monomethyl ether (manufactured by Wako Pure Chemical Industries, Ltd.)
PGMEA: propylene glycol monomethyl ether acetate (manufactured by Wako Pure Chemical Industries, Ltd.)

<Solvent (A2)>
GBL: γ-butyrolactone (manufactured by Wako Pure Chemical Industries, Ltd.)
HMP: 4-hydroxy-4-methy-2-pentanone (manufactured by Wako Pure Chemical Industries, Ltd.)
NMP: N-methyl-2-pyrrolidone (manufactured by Mitsubishi Chemical Corporation)

<Solvent (A3)>
IPA: isopropyl alcohol (manufactured by Wako Pure Chemical Industries, Ltd.)
MIBK: methyl isobutyl ketone (manufactured by Wako Pure Chemical Industries, Ltd.)

<Component (B)>
(B)-1: bis(2,2-bis(acryloxymethyl)-3-(2,2-bis(acryloxymethyl)-3-acryloxypropyl)propyl)-N,N′-hexane-1,6-diyldicarbamate (“KRM 8452”, manufactured by Daicel-Cytec, Ltd.)
(B)-2: tetraisopropoxysilane (manufactured by Shin-Etsu Chemical Co., Ltd.)
(B)-3: pentaerythritol tetraacrylate (manufactured by Daicel-Cytec, Ltd.)

<Component (C)>
(C)-1: titanium oxide particles (“TTO-51(N)”, manufactured by Ishihara Sangyo Kaisha, Ltd., having a particle size of 10 nm to 30 nm)
(C)-2: hollow silica particle dispersion (“Sluria 4320”, manufactured by JGC C&C, having a particle size of about 60 nm)

<Component (D)>
IRGARCURE 907: 2-methyl-1-[4-(methylthio)phenyl]-2-morpholinopropane-1-on (“Irgarcure 907”, manufactured by BASF)

<Other Components>
HCl aq.: 0.01 mol/L hydrochloric acid

### Comparative Example 1 and Examples 1 and 2

### Preparation of Coating Material

Solvents, a component (B), a component (C), and a component (D) shown in Table 1 were placed into a light-shielding container in the respective blending amounts (g) shown in Table 1 and strongly shaken and stirred for 10 minutes. Thereafter, the mixture was treated by a bead mill for 1 hour to obtain white liquid coating materials without precipitation.

TABLE 1

| | Solvent | Solvent | Solvent | Compo- | Compo- | Compo- |
|---|---|---|---|---|---|---|
| | (A1) | (A2) | (A3) | nent (B) | nent (C) | nent (D) |
| Comparative | — | — | IPA | (B)-1 | (C)-1 | (D)-1 |
| Example 1 | | | [450 g] | [15 g] | [35 g] | [0.75 g] |
| Example 1 | PNP | — | — | (B)-1 | (C)-1 | (D)-1 |
| | [450 g] | | | [15 g] | [35 g] | [0.75 g] |
| Example 2 | PNP | HMP | — | (B)-1 | (C)-1 | (D)-1 |
| | [450 g] | [5.02 g] | | [15 g] | [35 g] | [0.75 g] |

<Preparation of Optical Coating Film>

0.05 mL of the prepared coating material was dropped on a polished surface of a lens base material having a diameter of 30 mm (“S-BSL7”, made of glass, manufactured by OHARA Inc., having a thickness of 1 mm) whose surface was mirror-polished and spin-coated at 3000 rpm for 10 seconds using a spin coater (“ACT-220D II”, manufactured by Active Co., Ltd.). After the spin coating, using an ultraviolet light source (“LS-165UV”, manufactured by Sumita Optical Glass, Inc.), the coating material was irradiated with ultraviolet rays so as to have an accumulated amount of light of 1000 mJ/cm² at a wavelength of 365 nm.

Thus, a test piece in which an optical coating film (having a thickness of 100 nm) was formed on the glass base material was obtained.

The reflectivity of the optical coating film was measured using a spectrophotometer (“USPM-RU”, manufactured by Olympus Corporation), and then, the obtained result was input to Filmstar (simulation soft available from FTG Software Associates) to calculate the thickness of the optical coating film.

<Evaluation of Optical Coating Film>

(Unevenness Evaluation (1): External Observation)

The external appearance of the coating film was visually observed when the optical coating film of the test piece was irradiated with light from a light source (“Model LOPS”, manufactured by Olympus Corporation) and evaluated based on the following evaluation criteria. The results are shown in Table 2.

Good: A portion having a non-uniform color tone in the optical coating film was not observed.

Poor: A portion having a non-uniform color tone in the optical coating film was observed.

(Foreign Substance Evaluation)

The external appearance of the coating film was visually observed when the optical coating film of the test piece was irradiated with light from a light source (“Model LGPS”, manufactured by Olympus Corporation) and evaluated based on the following evaluation criteria. The results are shown in Table 2.

Good: Heterogeneous foreign substances other than the optical coating film were not observed.

Poor: Heterogeneous foreign substances other than the optical coating film were observed.

(Unevenness Evaluation (2): Reflectivity Measurement)

The reflectivity of the optical coating film was measured at five portions of the same test piece (at a center position of the test piece having a perfect circular shape, a position away from the center by 8 mm in the upper direction, a position away from the center by 8 mm in the right direction, a position away from the center by 8 mm in the lower direction, and a position away from the center by 8 mm in the left direction).

The reflectivity was measured at an incident angle of 90° and a wavelength range from 400 nm to 750 nm using a reflectivity measuring device (“USPM-RU”, manufactured by Olympus Corporation).

From the measurement results, graphs in which the vertical axis represented the reflectivity (%) at each position and the horizontal axis repented a wavelength (nm) were drawn. Each graph was shown in FIGS. 2 to 4.

As shifts among five curved lines in each graph (respective measurement results at the five portions) are decreased, a shift between the reflectivities in the same plane is decreased, and thus, the thickness unevenness of the optical coating film is reduced.

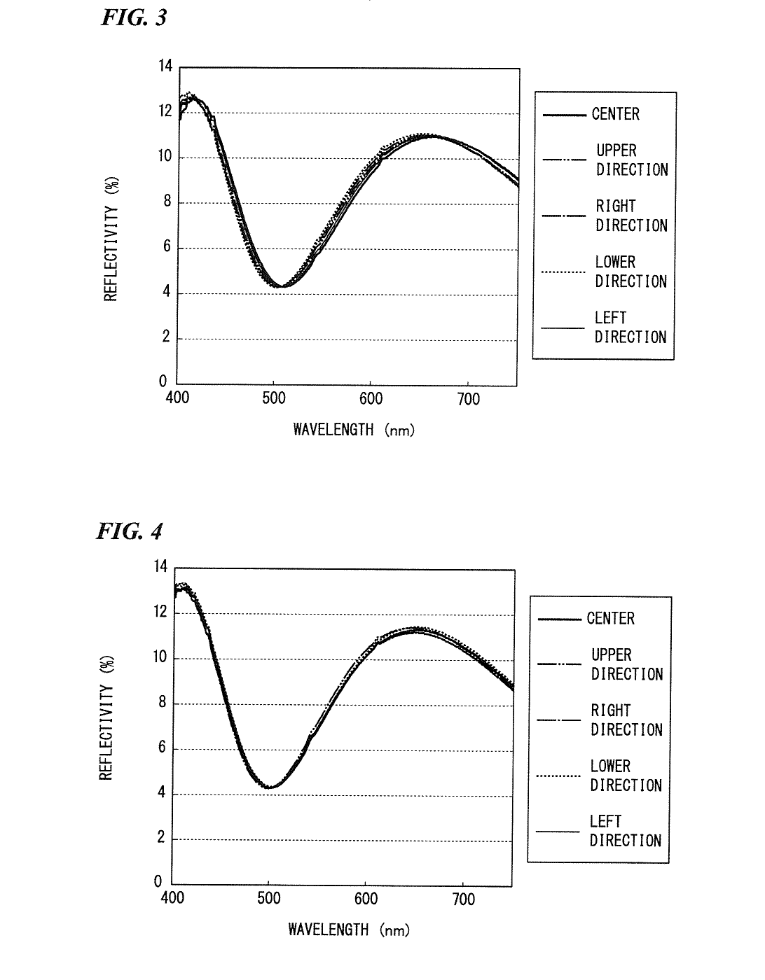

TABLE 2

| | | Uneveness | Foreign | Uneveness |
|---|---|---|---|---|
| | Solvent | evalaution | substance | evalaution |
| | (A) | (1) | evalaution | (2) |
| Comparative | IPA | Poor | Poor | Shown in FIG. 2 |
| Example 1 | | | | |
| Example 1 | PNP | Good | Poor | Shown in FIG. 3 |
| Example 2 | PNP + HMP | Good | Good | Shown in FIG. 4 |
| | (HMP 1%) | | | |

As seen from the above-described results, in the optical coating film in Comparative Example 1, a portion having a non-uniform color tone in the unevenness evaluation (1) was observed. In the unevenness evaluation (2), shifts among the five curved lines were observed in the graph. In addition, foreign substances were generated.

In contrast, although each coating film in Examples 1 and 2 has the same coating material composition except the used solvent (A), a portion having a non-uniform color tone was not observed in the unevenness evaluation (1). In the unevenness evaluation (2), the five curved lines in each graph were almost matched with one another and the result of Example 2 was particularly good. Thus, it was possible to confirm that an optical coating film having reduced unevenness and a uniform thickness was formed. Further, in Example 2, the generation of foreign substances was suppressed.

### Comparative Examples 2 and 3, Examples 3 to 8, and Comparative Example 4

### Preparation of Coating Material

Solvents, components (B), components (C), and HCl aq. shown in Table 3 were placed into a container in the respective blending amounts (g) shown in Table 3 and strongly shaken and stirred for 10 minutes to obtain coating materials.

TABLE 3

| | | | | | | Other |
|---|---|---|---|---|---|---|
| | Solvent | Solvent | Solvent | Compo- | Compo- | compo- |
| | (A1) | (A2) | (A3) | nent (B) | nent (C) | nents |
| Comparative | — | — | IPA | (B)-2 | (C)-2 | HCl aq. |
| Example 2 | | | [400 g] | [20 g] | [20 g] | [1 g] |
| Comparative | — | — | MIBA | (B)-2 | (C)-2 | HCl aq. |
| Example 3 | | | [400 g] | [20 g] | [20 g] | [1 g] |
| Example 3 | PGME | — | — | (B)-2 | (C)-2 | HCl aq. |
| | [400 g] | | | [20 g] | [20 g] | [1 g] |
| Example 4 | PGMEA | — | — | (B)-2 | (C)-2 | HCl aq. |
| | [400 g] | | | [20 g] | [20 g] | [1 g] |
| Example 5 | PNP | — | — | (B)-2 | (C)-2 | HCl aq. |
| | [400 g] | | | [20 g] | [20 g] | [1 g] |
| Example 6 | PNP | HMP | — | (B)-2 | (C)-2 | HCl aq. |
| | [400 g] | [8 g] | | [20 g] | [20 g] | [1 g] |
| Example 7 | PNP | GBL | — | (B)-2 | (C)-2 | HCl aq. |
| | [400 g] | [8 g] | | [20 g] | [20 g] | [1 g] |
| Example 8 | PNP | NMP | — | (B)-2 | (C)-2 | HCl aq. |
| | [400 g] | [8 g] | | [20 g] | [20 g] | [1 g] |
| Comparative | PNP | — | — | (B)-3 | (C)-2 | — |
| Example 4 | [400 g] | | | [20 g] | [20 g] | |

<Preparation of Optical Coating Film>

0.05 mL of the prepared coating material was dropped on a polished surface of a lens base material having a diameter of 30 mm (made of glass, “S-BSL7”, manufactured by OHARA Inc., having a thickness of 1 mm) whose surface was mirror-polished and spin-coated at 3000 rpm for 10 seconds using a spin coater (“ACT-220D II”, manufactured by Active Co., Ltd.). After the spin coating, the coating material was dried at 25° C. for 1 hour. Thus, a test piece in which an optical coating film (having a thickness of 100 nm) was formed on the glass base material was obtained.

<Evaluation of Optical Coating Film>

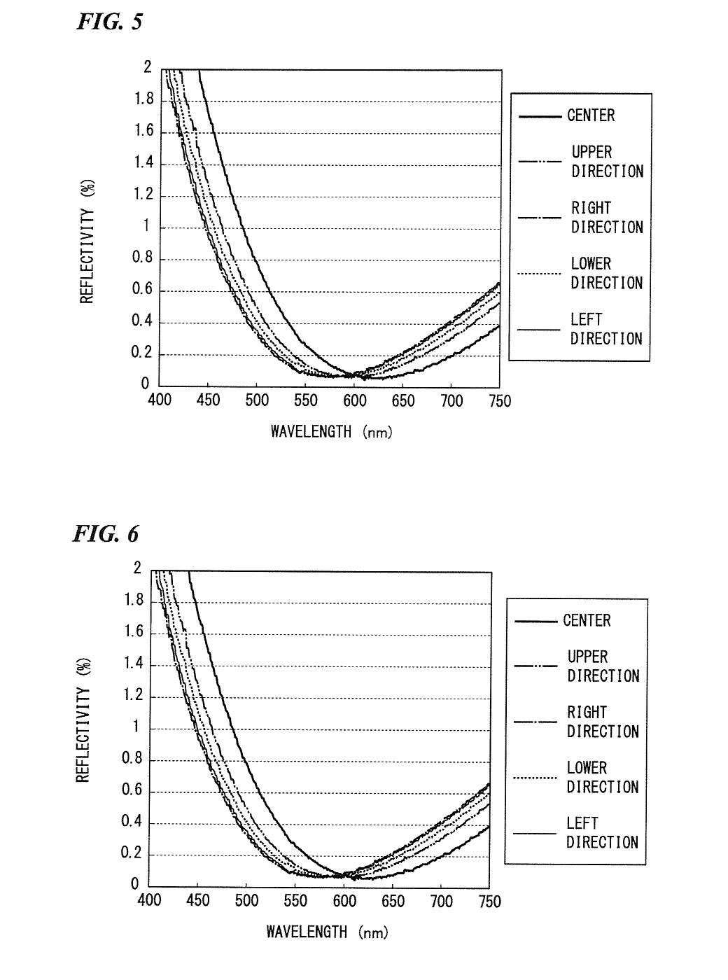

The unevenness evaluation (I), foreign substance evaluation, and unevenness evaluation (2) of the prepared test piece were performed as in the same procedure as described above. The results are shown in Table 4 and FIGS. 5 to 13.

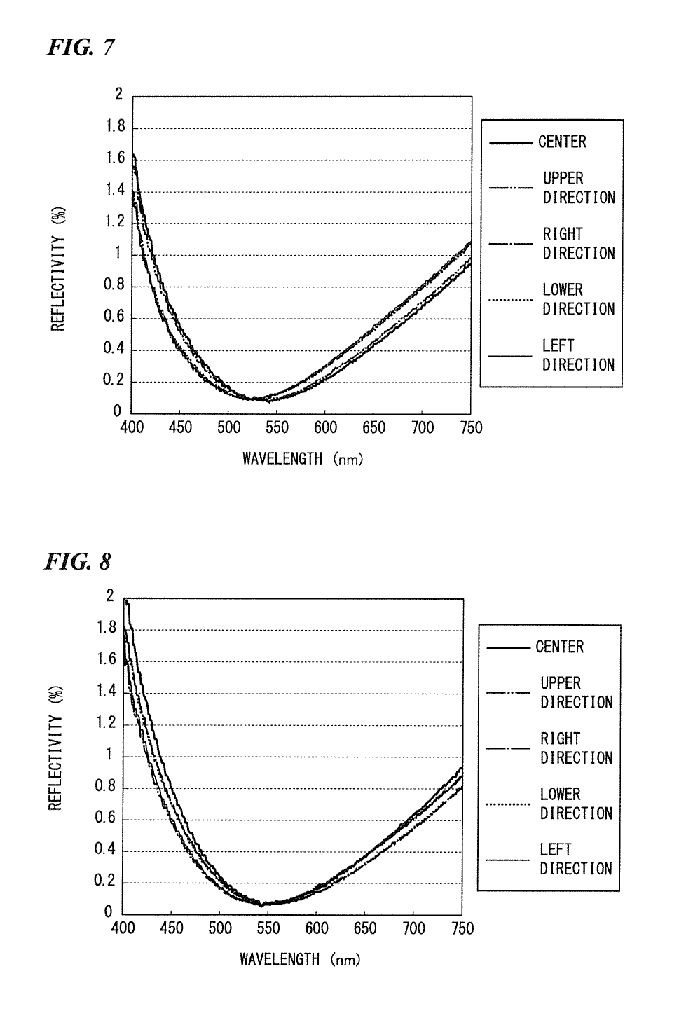

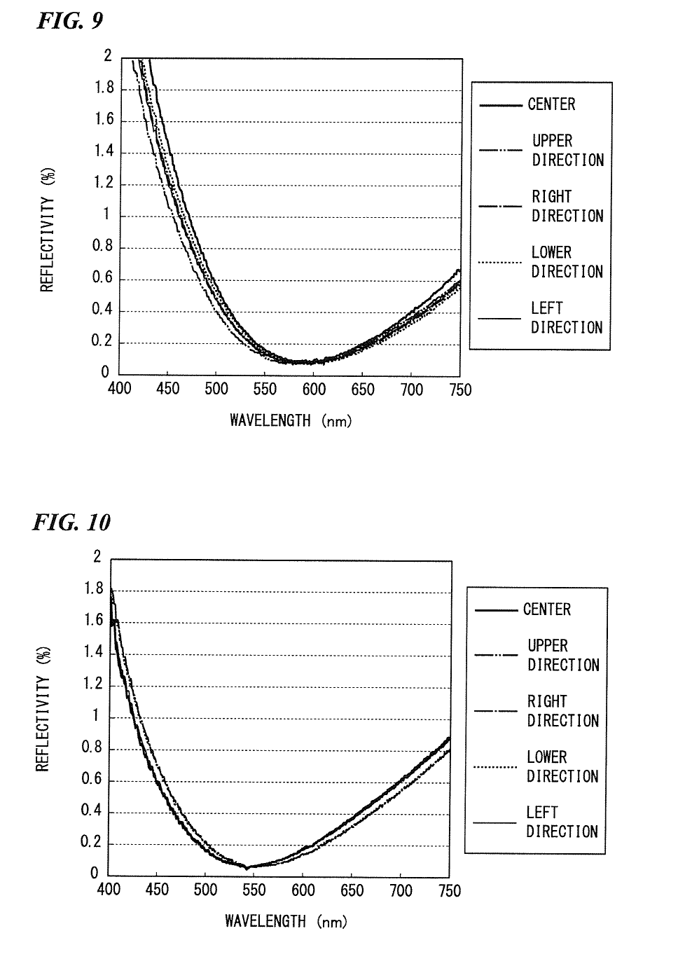

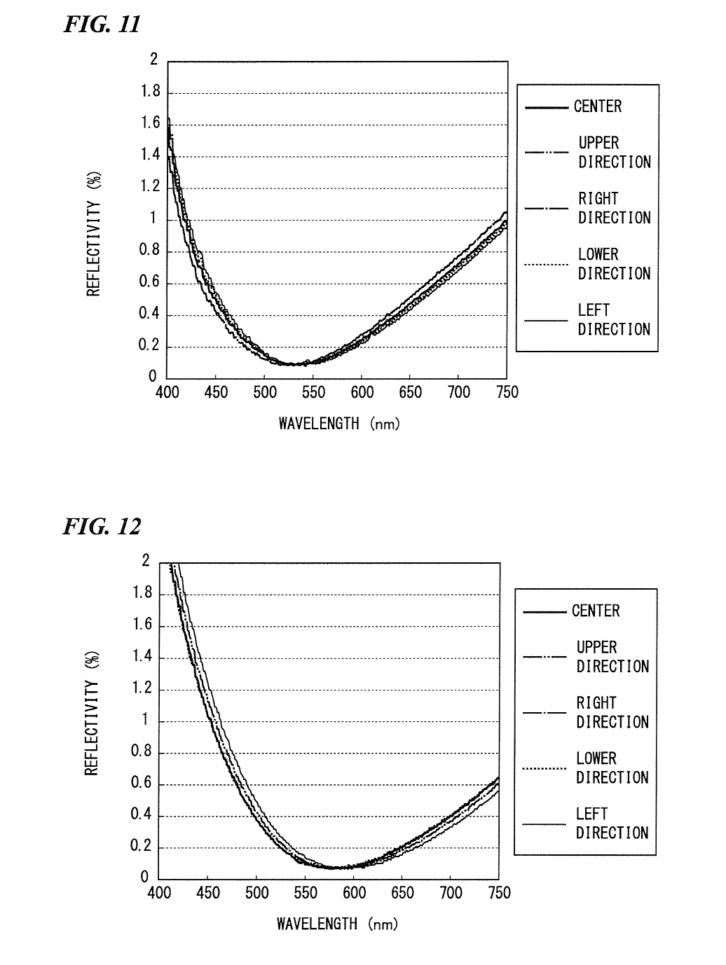

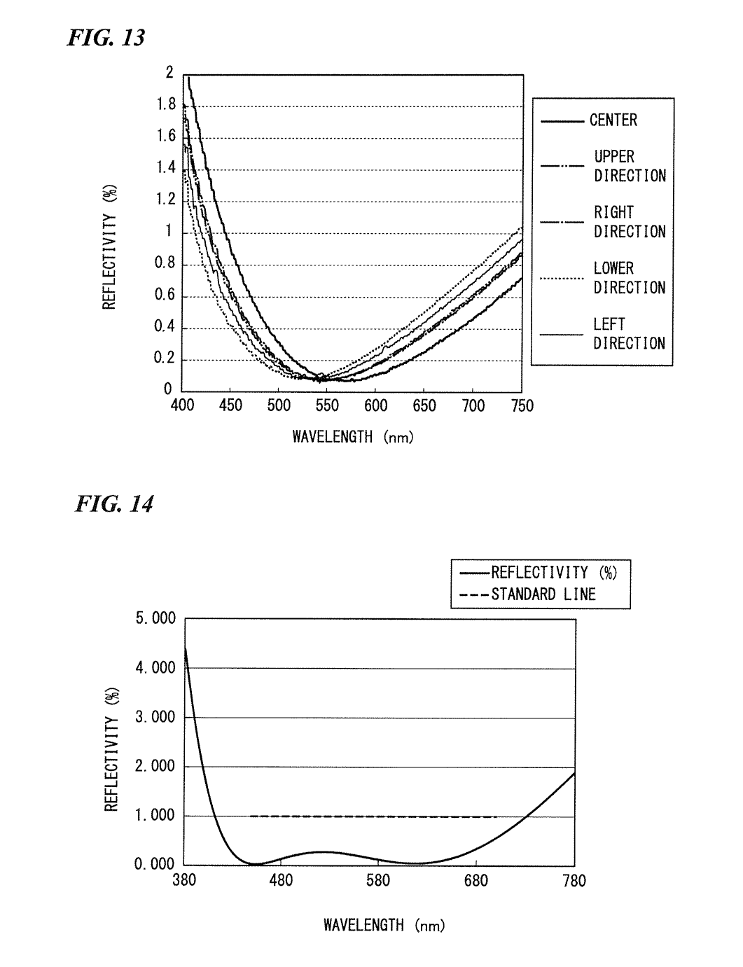

TABLE 4

| | | Unevenness | Foreign | Unevenness |
|---|---|---|---|---|
| | Solvent | evaluation | substance | evaluation |
| | (A) | (1) | evaluation | (2) |
| Comparative | IPA | Poor | Poor | Shown in FIG. 5 |
| Example 2 | | | | |
| Comparative | MIBK | Poor | Poor | Shown in FIG. 6 |
| Example 3 | | | | |
| Example 3 | PGME | Good | Poor | Shown in FIG. 7 |
| Example 4 | PGMEA | Good | Poor | Shown in FIG. 8 |
| Example 5 | PNP | Good | Poor | Shown in FIG. 9 |
| Example 6 | PNP + HMP | Good | Good | Shown in FIG. 10 |
| | (HMP 1.8%) | | | |
| Example 7 | PNP + GBL | Good | Good | Shown in FIG. 11 |
| | (GBL 1.8%) | | | |
| Example 8 | PNP + NMP | Good | Good | Shown in FIG. 12 |
| | (NMP 1.8%) | | | |
| Comparative | PNP | Poor | Poor | Shown in FIG. 13 |
| Example 4 | | | | |

As seen from the above-described results, in the optical coating films in Comparative Examples 2 and 3, a portion having a non-uniform color tone was confirmed in the unevenness evaluation (1). In the unevenness evaluation (2), shifts among the five curved lines in each graph were observed. Foreign substances were generated.

On the contrary, although each coating film in Examples 3 to 8 has the same coating material composition except the used solvent (A), a portion having a non-uniform color tone was not observed in the unevenness evaluation (1). In the unevenness evaluation (2), the amount of shifts among the five curved lines in each graph was smaller than that in Comparative Examples 2 and 3, and particularly, the five curved lines in each graph were almost matched with one another in Examples 6 to 8. Thus, it was possible to confirm that an optical coating film having reduced unevenness and a uniform thickness was formed. Further, in Examples 6 to 8, the generation of foreign substances was suppressed.

In Comparative Example 4 in which (B)-3 was used as the component (B), a portion having a non-uniform color tone was observed as in Comparative Examples 2 and 3 in the unevenness evaluation (1) and shifts among the five lines in each graph in the unevenness evaluation (2) were observed. Foreign substances were generated.

### Example 9

The optical element having the configuration shown in FIG. 1 was measured as follows.

0.05 mL of the prepared coating material in which 5 parts by mass of Irgarcure 907 (manufactured by BASF) was added to 100 parts by mass of a 5 mass % PNP solution of KRM 8452 (manufactured by Daicel-Cytec, Ltd.) was dropped on a polished surface of a lens base material having a diameter of 30 mm (made of glass, “S-BSL7”, manufactured by OHARA Inc., having a thickness of 1 mm and a refractive index of 1.516) whose surface was mirror-polished, and then spin-coated at 3000 rpm for 10 seconds. The coating film was irradiated with light from an ultraviolet light source (“LS-165UV”, manufactured by Sumita Optical Glass, Inc.) so as to have an accumulated amount of light of 1000 mJ/cm² at a wavelength of 365 nm. Thus, an intermediate refractive index layer (having a refractive index of 1.59 and a thickness of 56 nm) was formed.

An optical coating film (high refractive index layer, having a refractive index of 1.84 and a thickness of 132 nm) was formed on the intermediate refractive index layer using the coating material prepared in Example 2 in the same procedure as in Example 2.

An optical coating film (low refractive index layer, having a refractive index of 1.34 and a thickness of 96 nm) was formed on the high refractive index layer using the coating material prepared Example 7.

Thus, an optical element including a multilayer film having a three-layer structure of an intermediate refractive index layer, a high refractive index layer, and a low refractive index layer on the surface of the lens base material was obtained.

The reflectivity of the optical coating film was measured using a spectrophotometer (“USPM-RU”, manufactured by Olympus Corporation), and then, the obtained result was input to Filmstar (simulation soft available from FTG Software Associates) to calculate the refractive index and the thickness of each layer.

The reflectivity of the multilayer film was measured at the center position of the obtained optical element.

The reflectivity was measured at an incident angle of 90° and a wavelength range from 380 nm to 780 nm using a reflectivity measuring device (“USPM-RU”, manufactured by Olympus Corporation).

From the measurement result, a graph in which the vertical axis represented the reflectivity (%) and the horizontal axis repented a wavelength (nm) was drawn.

The graph was shown in FIG. 14. In the graph, the solid line represents the measurement result of the reflectivity. The broken line represents the standard line. When the reflectivity within a wavelength range of 450 mm to 700 nm is 1% or less, the optical coating film has sufficient reflection preventing performance as a reflection preventing film.

As shown in FIG. 14, the formed multilayer film has sufficient reflection preventing performance as a reflection preventing film.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A coating material for forming an optical coating film which constitutes a reflection preventing film provided on a lens base material, the coating material comprising:
a solvent (A);
a compound (B) which contains a polymerizable functional group; and
a metal oxide particle (C),
wherein the solvent (A) contains at least one solvent (A1) selected from a group consisting of propylene glycol monopropyl ether, propylene glycol monomethyl ether, and propylene glycol monomethyl ether acetate, and
the compound (B) contains a compound (B1) which contains two or more urethane bonds in one molecule, or metal alkoxide (B2).

2. The coating material according to claim 1,
wherein the solvent (A) further contains at least one solvent (A2) selected from a group consisting of γ-butyrolactone, 4-hydroxy-4-methyl-2-pentanone, N-methyl-2-pyrrolidone, and 3-methoxy-1-butanol, and
a content of the solvent (A2) is 0.5% by mass to 5% by mass with respect to a total amount of the coating material.

3. An optical coating film which constitutes a reflection preventing film provided on a lens base material, comprising:
the coating material according to claim 1.

4. An optical coating film which constitutes a reflection preventing film provided on a lens base material, comprising:
the coating material according to claim 2.

5. An optical element comprising:
a lens base material; and
a reflection preventing film provided on the lens base material,
wherein the reflection preventing film is a multilayer film in which three or more layers are stacked, and
at least one layer among the layers which constitutes the multilayer film is an optical coating film formed of the coating material according to claim 1.

6. An optical element comprising:
a lens base material; and
a reflection preventing film provided on the lens base material,
wherein the reflection preventing film is a multilayer film in which three or more layers are stacked, and
at least one layer among the layers which constitutes the multilayer film is an optical coating film formed of the coating material according to claim 2.
